(19) United States
(12) Patent Application Publication
(10) Pub. No.: US 2001/0031329 A1
(43) Pub. Date: Oct. 18, 2001

(54) Unitary vapor retarder for chilled pipe insulation

(76) Inventor: Roy E. Shaffer, Granville, OH (US)

Correspondence Address: OWENS CORNING, 2790 COLUMBUS ROAD, GRANVILLE, OH, 43023, US

(21) Appl. No.: 09/737,051

(22) Filed: Dec. 14, 2000

Related U.S. Application Data
(60) Provisional application No. 60/177,515, filed on Jan. 21, 2000.

(51) Int. Cl. B32B 1/08

(52) U.S. Cl. 428/36.9; 428/99

(57) ABSTRACT

An insulation system exhibiting superior ability to maintain insulation in a dry and effective condition and to remove moisture that condenses near a cold pipe is disclosed. The insulation system features a wicking material that surrounds the pipe and passes through a slit in the insulation. A vapor retarder surrounds the outer perimeter of the insulation. At the seam, a flap, containing openings that permit evaporation of moisture, extends over the slit and attaches to the vapor retarder. The vapor retarder provides enhanced performance by preventing the seepage of moisture back into the bulk of the insulation.

This application is a Continuation-In-Part of Provisional U.S. Patent Application 60/177,515 herein incorporated in its entirety.

### TECHNICAL FIELD AND INDUSTRIAL APPLICABILITY OF THE INVENTION

The invention is directed toward an insulation article, more particularly an insulation article for a cold pipe exhibiting a wicking ability to readily transport moisture from the interior to the outside of the pipe and insulation article assembly, where the moisture can evaporate without causing damage to the pipe or insulation. In one embodiment of the invention a unitary vapor retarder, including perforations to allow the evaporation of water from within the vapor retarder, encompasses the pipe insulation and wicking material.

### BACKGROUND OF THE INVENTION

It is known to insulate pipes with insulating material made from fiberglass or other materials having a large amount of interstitial voids. The void structure provides an insulating effect, but also allows water vapor to pass from the outside environment to the surface of the pipe. When the pipe contains a liquid or gas at sub-ambient temperatures, the moisture will condense onto the pipe. Liquid water trapped inside the insulation reduces the insulating effect and also tends to degrade the structure of the insulation. The liquid water may also pool within the insulation product and eventually drip causing stains in ceiling materials installed beneath pipes.

Since it is difficult to build or maintain a hermetically sealed pipe insulation structure, it is inevitable that moisture will invade the insulation through cracks, fissures, joints, etc. of the insulation to eventually condense on the pipe. Therefore it is highly desirable to have a mechanism or structure which can transport water away from the pipe to the exterior of the insulation, where it can evaporate.

Vapor retarding products are utilized in the insulation of piping systems that operate below ambient temperatures. The vapor retarders are usually based upon thin films formed from metal foils or polymers or the vapor retarders may be formed of closed cell foamed polymers, foam glass, mastics. Some retarders lack mechanical strength and resistance to punctures and abrasion. As a result, the vapor retarders become porous and allow moisture to penetrate inside the insulation. Some vapor retarder materials are also inherently porous. Metal foils are prone to pin holes arising from impurities in the metal or due to handling during manufacturing and installation. Metal foils are also prone to corrosion in the presence of water. Polymers are intrinsically permeable due to their molecular structure, and they must be sufficiently thick to minimize the permeability.

A conventional vapor retarder technology is to surround the pipe insulation with a retarder made up of a sandwich structure of aluminum foil and Kraft paper with an internal layer of fiberglass scrim. The conventional vapor retarder is placed on the outside of the insulation so that the aluminum foil faces the insulation and the Kraft paper faces the outer environment. An adhesive is used to join the vapor retarder to the insulation. Some products are made of foil, Kraft paper and, polyethylene. The foil retarder being on the outside surface. The polyethylene is heated and used as the adhesive.

The conventional art has been found to be deficient because of the difficulty in providing and maintaining retarder properties of the installed product. Difficulties in sealing the horizontal and butt-end joints as well as the inevitable field-fabricated parts allow water vapor to penetrate and condense on the chilled pipes. Embrittlement of polymer insulating products and sealants allow vapor to enter through cracks, crevices and failed sealed joints. Mechanical breaks, punctures, etc., also provide portals into which moisture can invade.

As has been shown, there is a need for a superior insulating product that allows any condensed water to be carried to the surface of the insulation by capillary action and allowed to evaporate to the atmosphere. The insulating product needs to be robust and easy to install. The insulating product needs to operate in an efficient manner, so that the insulation will be kept dry even when the vapor retarder is permeable.

A known system to remove moisture from an insulation system has been developed by Korsgaard, U.S. Pat. No. 5,441,083 (herein incorporated by reference). Korsgaard discloses an insulation system for a cold pipe that includes an inner water-absorbing layer, an intermediate heat insulating layer, and an outer water-absorbing layer, where the inner and outer layers are in contact through a slot. Korsgaard teaches a plastic film covering the area over the slot and a tenuous and indirect path to the environment into which the water evaporates. Korsgaard teaches a plastic film around the insulation and a separate plastic film adhered to the wicking material at a longitudinal slit to seal the slit. Korsgaard also teaches a plastic film to surround the insulation with a flap that extends over the slit and the wicking material extends beyond the flap. However, this laminate serves to diminish the functional surface area from which water may evaporate to the atmosphere or extends the distance the liquid water must travel via capillary action in order to evaporate to the atmosphere.

### SUMMARY OF THE INVENTION

The present invention provides a technology for the efficient removal of condensed water from the surface of insulated chilled pipes.

The invention provides a more efficient and effective technology for transporting water from chilled pipes to the surface than the conventional insulation technology.

The invention, in part, also provides an insulation article having a vapor retarder. The vapor retarder material can be any polymer or foil film used for that purpose. The vapor retarder inhibits the transfer of moisture from the environment and the insulation while allowing for the evaporation of moisture from the wicking material to the environment. In a preferred embodiment the vapor retarder includes a flap which extends over the slit in the insulation material. The flap preferably includes perforations or holes in the area of the wicking material to allow water vapor to evaporate from the wick.

It is preferable according to the invention to use a wick to provide a media for capillary removal of water that condenses on insulated chilled pipes. Polymeric wick materials such as polyester or nylon can be joined to the vapor retarder by thermal welding to form a continuous loop. A variety of vapor retarder materials may be thermally welded to a polymer fabric. In addition, materials such as polyester nylon can attach to fibrous glass insulation products without the aid of adhesives or additional mechanical attachments. Friction firmly attaches to the wicking media to fibrous glass insulation to allow fabrication, shipment and installation.

### BRIEF DESCRIPTION OF THE DRAWINGS

The present invention will become more fully understood from the detailed description given hereinbelow and the accompanying drawings which are given by way of illustration only, and thus do not limit the present invention.

FIGS. 1A-1D are cross sectional views of preferred embodiments of the present invention.

FIGS. 2A-2C are plan views of preferred embodiments of the present invention including various perforations including micropores.

### DETAILED DESCRIPTION AND PREFERRED EMBODIMENTS OF THE INVENTION

Objectives of the present invention will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

The insulation assembly 1 includes a tubular sleeve of insulation 4, such as mineral or polymer insulation; the sleeve includes a slit 16 from end to end to allow the installation of the assembly 1 on a pipe 2. A wicking material 8 is placed in the interior of the sleeve 4 and extends outwardly through slit 16 and terminates outside the sleeve 4 in outer edges 24, 26. A double layer of wicking material 8 is disposed inside of the longitudinal slit 16

The present invention provides an insulation assembly 1 that is quickly and easily installed on pipe 2. Typically, the insulation assembly of the present invention is installed on a pipe 2, flap 30 is folded over the edges 24, 26 of the wicking material 8 and is typically adhered to the exterior of vapor retarder 10.

The wicking material 8 is preferably a non-woven material that can be formed from a polymer or natural fiber. One suitable polymer for the wicking material is rayon. Rayon fibers are striated, or include channels, along the length of the fiber, which provide capillary channels in individual fibers so the wick does not rely upon capillary action formed in the channel between two adjacent fibers. Rayon fibers are striated by their manufacture; it is possible to form striations in other polymers for example by forming trilobal fibers of any polymer material. Any polymer fiber exhibiting a striated structure would provide improved wicking properties. The wicking material can have a vapor retarding material laminated to the interior surface to inhibit water vapor from penetrating the insulation and condensing onto the pipe surface.

The wick transports any water that condenses on the pipe to the surface of the insulation assembly and allows the water to evaporate without dripping. The wicking material 8 is made from a porous or semi-porous, fibrous material. Rayon is useful in the present invention and may be thermally or ultrasonically welded so that it may be incorporated into the piping and insulation without utilizing coatings and/or adhesives.

There are several methods to form the wicking web. The fibers can be laid down dry and the acrylic emulsion can be applied by flooding and extracting. Curing is usually carried out by heating the web. Alternately, the fiber can be laid down dry, followed by spraying on the emulsion and baking to cure. Standard fiber binding emulsions such as acrylic or EVA (ethylene vinyl acetate) can be utilized. A black or dark color wick has the aesthetic advantage of masking stains on the surface of the insulation assembly.

The wicking material can be used with all standard insulation materials. The insulation materials include mineral wool, fiberglass, elastomers, rubber, foam, polyester, etc. The wicking material is compatible with all types of piping systems.

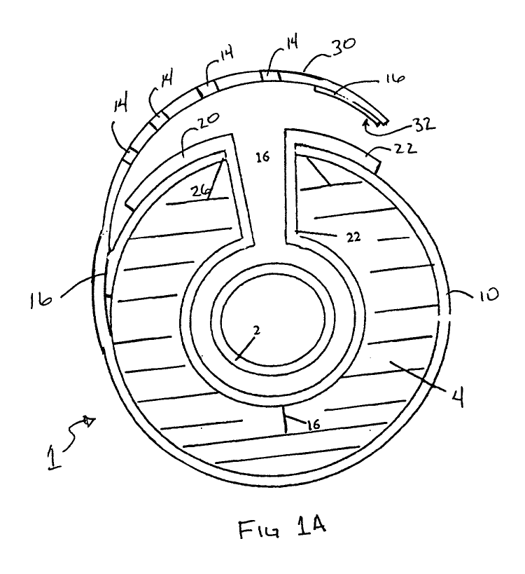

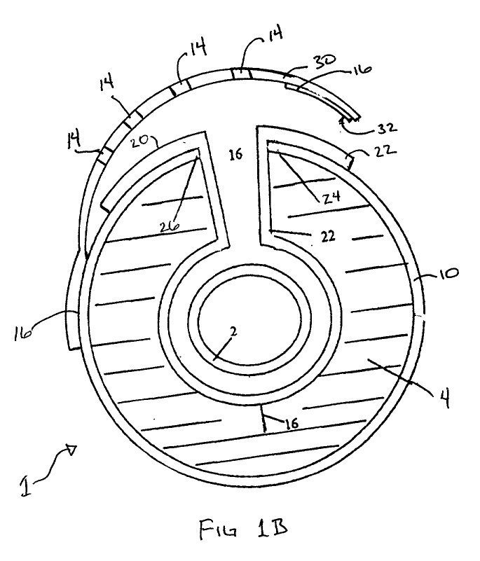

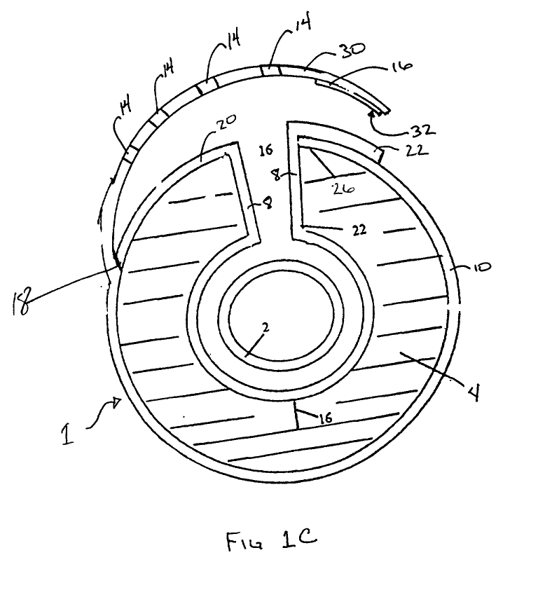

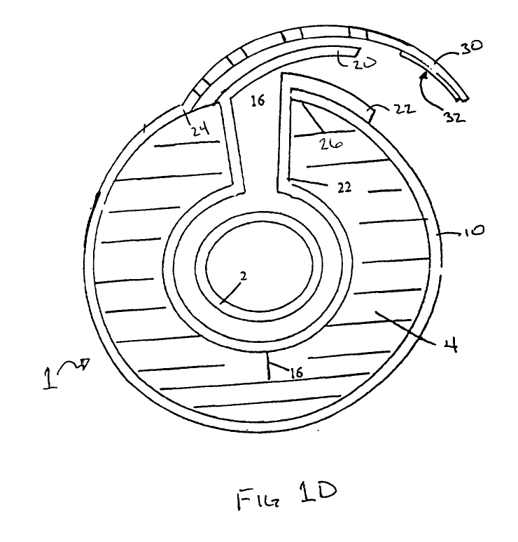

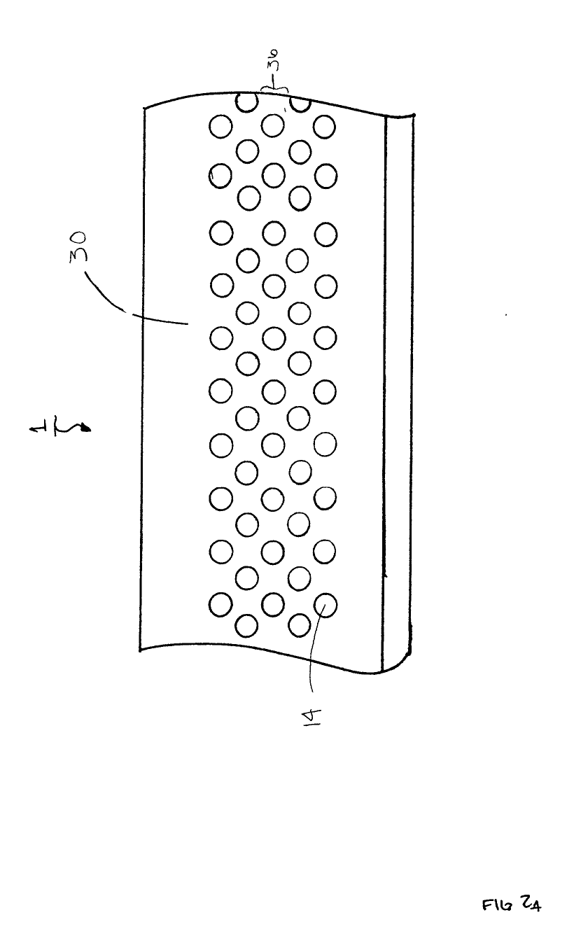

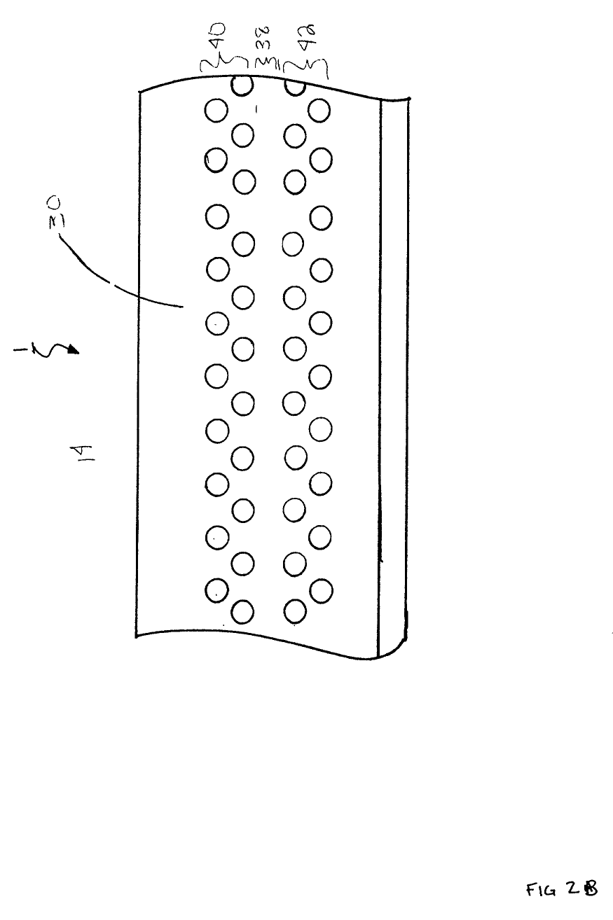

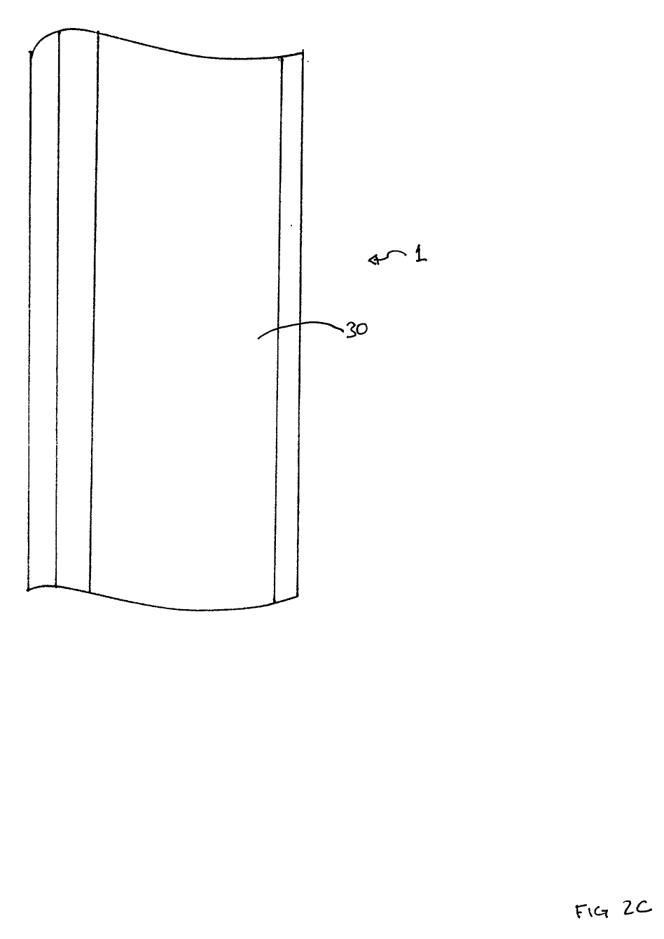

FIG. 1 is a cross sectional view of an embodiment of the present invention. A pipe 2 is made of copper, iron, mild steel, stainless steel, inconel, brass, other metal, PVDF, polypropylene, PVC, Polyethylene, nylon, or other suitable plastic. The pipe can optionally be coated with an anticorrosive coating such as epoxy (not shown). Surrounding the pipe 2 is a cylindrical layer of insulating material 4. The insulating material can be made of mineral wool, fiberglass, plastic, etc.

The vapor retarder 10 is a preferred component of the invention. A perfect seal of the insulation assembly is difficult to attain, since any vapor retarder will tend to become compromised at a seam, a crack, an accidental puncture, etc. However, even if a perfect seal is not attained, the vapor retarder 10 is still necessary to retard the ingress of water into the insulation 4 to condense on the pipe 2, where it subsequently must be removed by wicking. The wicking material 8 is preferably formed from one piece of material such that the wicking material enters the insulation through a longitudinal slit 16 in the insulation 4. The longitudinal slit 16 in the insulation 4 enables the insulation to open or clamshell so as to allow the installation of the insulation on the pipe 2.

Surrounding the insulating material 4 is a vapor retarder 10 that inhibits the transfer of moisture of between the environment and the insulation. The vapor retarder is a sheet of material that surrounds the insulation. The vapor retarder 10 preferably comprises polyester, polypropylene, polyethylene or vinyl. The edges 20, 22 of the vapor retarder are preferably heat or ultrasonically laminated to the edges 24, 26 of the wick. Typically the perm value of the vapor retarder should be as low as possible but preferably less than 0.5 and more preferably less than 0.2. The vapor retarder 10 will encompass the outer diameter of the insulation 4. In one embodiment of the present invention, the edges 20,22 of the vapor retarder 10 are adjacent at seam 16 as shown in FIG. 1A. The reduced distance between the edges 20, 22 inhibits the ingress of ambient moisture and the re-evaporation of liquid water from the wick and subsequent condensation on the pipe 2. This structure reduces the thermodynamic cost of water evaporation and reduces the probability of overloading of the wick and liquid water dripping from the wick. At seam 16 the flap 30, having openings 14, extends over the slit 16 and attaches to the vapor retarder 10 by means of a fastener 16.

When the evaporation rate is less than the rate of ingress of water vapor condensing on the pipe, the system becomes saturated and the wick may drip and the insulation will become damp will compromise thermal performance. To prevent saturation flap 30 includes openings 14 to expose a predetermined amount of wicking material. The openings 14 may be of any size, typically the openings or perforations may be slots or holes having areas of between 0.04 in² and 3 in². The openings may be formed by any known method for example punching and laser cutting may be used. When using discrete openings, as opposed to micropores (discussed below), one important criterion is the amount of wicking material that is exposed to the atmosphere. The exposed surface area required is dependent on the diameter of the insulation assembly and the temperature of the pipe, as well as ambient temperature and relative humidity. Typically, the openings should reveal more than about 1 in² per linear inch and preferably about 1.5 in² per linear inch. In addition, films which are microporous and are impermeable to liquid water but which allow the transmission of water vapor are suitable. One such microporous film is disclosed in U.S. Pat. No. 6,013,151 to Wu et al., herein incorporated by reference, which shows an incrementally stretched film having a vapor transmission rate of between 1000-4000 g/m²/day.

The route of the vapor retarder 10 around the insulation assembly can be traced referring to FIG. 1A. From the slit 16 the vapor retarder material loops around the outer circumference of the insulation 4. A flap 30 is joined to vapor retarder 10 at the seam 18. An extra portion of the vapor retarder material extends to form a flap 30, which is sealed to the outside of the assembly to inhibit moisture and extraneous material from entering the slit. Flap 30 may be thermally bonded or adhesively bonded to the outer periphery of the vapor retarder 10 at seam 28. Heat sealing can be performed using a heat bar or the seam can be made using an adhesive or ultrasound. The seam 18 in the vapor retarder material 10 can also be formed by using an adhesive. The adhesives can include such standard adhesives as thermoplastic adhesives, UV curable adhesives and latex adhesives. One of the disadvantages of using adhesives is their extra cost. An important disadvantage of using adhesives is that the adhesive itself adds flammable material to the insulation, thereby increasing the fire hazard.

FIG. 1B shows an alternative embodiment in which the flap 30 is an integral part of the vapor retarder 10 and a separate extension 18 of vapor retarder is bonded to the interior of vapor retarder 10 where flap 30 separates from insulation 4. A third embodiment of the present invention is shown in FIG. 1C in which the edge 26 of wick material 8 extends from the slit to the vapor retarder 10 where flap 30 separates from insulation 4. FIG. 1D shows a fourth embodiment, in which the edge 26 of wick material 8 extends from the slit and is not attached to the vapor retarder 10. Flap 30 separates from insulation 4 at a position at or near the slit. The insulation assembly is installed on pipe 2, wicking material edge 26 is then wrapped over wicking edge 24 and flap 30 is secured to vapor retarder 10.

There are a number of options for sealing the flap. If the pipe has a small circumference, (1-inch copper pipe, 1-inch insulation width), frictional forces or static electricity may be sufficient to seal the flap 30. Preferably a strip of adhesive 16 (usually acrylic based, but other adhesives can be used) is applied to the flap 30, and the adhesive is covered by release paper 32. After installing the insulation, on the pipe, the release paper 32 can be peeled off and the flap 30 pressed flush with the outside of the insulation assembly so as to form a seal. Heat or ultrasonic welding can also be used to form the seal. The fully installed assembly will have the flap lying flush with the side of the assembly so that the flap has an arc of curvature approximately the same as the outside of the assembly.

A hermetic seal is not required for the invention because the wick can remove moisture. Thus, there are a number of alternative options for sealing the flap 30. The sealing options can include a non-continuous strip of pressure sensitive tape, hook-and-loop fastener technology, wire ties, nylon or plastic ties, staples, hot melt adhesives, other adhesives, heat welding and any other type of mechanical gripping such as pins, clamps, snaps, etc.

Since a hermetic or moisture-proof seal is not necessary the insulation gives superior results for less exacting tolerances for sealing and placing (and construction) of the vapor retarder. The invasion of moisture into the insulation can be tolerated, since it can be wicked. However, it is preferred that moisture be prevented from entering the insulation for thermodynamic reasons, the wicking mechanisms still depends on the evaporation of water, which has a high thermal cost. Therefore, the wicking out of excess water will result in a heat pump, which reduces the efficiency of the insulation, and results in higher energy costs.

The film thickness is an important parameter for the performance of vapor retarders. A metal foil vapor retarder frequently has a thickness of 0.35 mil. Impurities in the metal will result in the formation of pinholes when the metal is formed into a thin sheet. The pinholes are the mechanism by which moisture can pass through a metal foil vapor retarder. Moisture passes through a polymeric vapor retarder by a diffusion mechanism. Increasing the polymer film thickness will reduce the permeability of the vapor retarder. A thicker film will improve the resistance to mechanical damage and reduce water vapor permeability. The improvements in these properties must be balanced against the desire to meet industry requirements for flame spread such as UL 723 or ASTM E-84. Alternatively, two thinner layers or a coextrusion of polymer film can be used in place of one thicker layer.

Permeability is also dependent on the polymeric material. Permeability of vapor barriers and vapor retarding materials are measured according to ASTM E96 Proc. A. The unit of measurement of permeability is the Perm. Polyester film such as MELINEX 339 manufactured by DuPont, Circleville, Ohio is preferred for the vapor retarder. Other materials suitable for vapor retarders include polypropylene manufactured by Formosa, Plastics, polyethylene, nylon, polyester films such as MYLAR, polycarbonate polymer (SARAN), polyvinylidene chloride, polyvinylidene copolymers, any film forming copolymers, and co-extruded products which, for example, can contain polyester (which adds stiffness).

Continuous manufacture (not depicted) of the insulation assembly can be performed as part of the insulation manufacturing process. Insulation is manufactured by a continuous extrusion process. The cylinder of insulation continuously emerges from the extrusion head and is slit and then cut off into predetermined lengths. In the continuous manufacturing process both the vapor retarder and wicking materials are continuously fed from rolls in the direction of extrusion. Guides will ensure the proper wrapping of the vapor retarder and wicking material around the extruded cylinder of insulation. After slitting the insulation into a clamshell, the wicking material is folded into a loop and the seam formed, e.g., with a heat sealer. A blade is positioned so as to push the wicking material into the clamshell opening. The insulation is finally cut into predetermined lengths.

It is understood that the foregoing description and specific embodiments shown herein are merely illustrative of the best mode of the invention and the principles thereof, and that modifications and additions may easily be made to the apparatus and method by those skilled in the art without departing from the spirit and scope of the invention, which is therefore understood to be limited only by the scope of the appended claims.

1. An insulation system which comprises:
a tubular layer of insulation having an inner periphery and an outer periphery including a longitudinal slit therein for allowing a pipe to be received within the inner periphery of the insulation;
a wick disposed within the inner periphery of the insulation and extending through the slit to the outer periphery of the insulation;
a vapor retarder on the outer periphery of the insulation, including a flap initiating on a first side of the slit which extends over the slit and may be attached to the vapor retarder on a second side of the slit.

2. The insulation system according to claim 1, wherein the flap further includes perforations of sufficient size to allow vapor to evaporate from the wicking material at a rate equal to or greater than the allowed ingress formed condensed water.

3. The insulation system according to claim 2, wherein the flap is formed of a microporous material.

4. The insulation system according to claim 1, wherein the perforations have an open area of at least 1 in² per linear inch of pipe.

5. The insulation system according to claim 1, wherein the perforations have an open area of at least 1.5 in² per linear inch of pipe.

6. The insulation system according to claim 1 wherein the vapor retarder extends from the first side of the slit to the second side of the slit to encompass the layer of insulation includes a flap attached to the vapor retarder on the first side of the slit and extending to the second side of the slit and attachable to the vapor retarder at the second side of the slit.

7. The insulation system according to claim 6, wherein the vapor retarder covers the entire outer periphery of the tubular layer of insulation.

8. The insulation system according to claim 1, wherein the vapor includes the flap which extends to the first side of the slit, the flap being attachable to the vapor retarder at the second side of the slit to form a tubular member.

9. The insulation system according to claim 8, further comprising an extension to the vapor retarder extending from the flap to the first side of the slit.

10. The insulation system according to claim 1, further comprising a wicking material within the tubular layer and extending through the slit.

11. The insulation system according to claim 10, wherein said wicking material is secured to the outer periphery of the vapor retarder.

12. The insulation system according to claim 1, wherein the material of the wicking material is selected from the group consisting of striated polymer fibers.

13. The insulation system of claim 12, wherein the material is a sheet formed of fibers that are chemically or thermally bonded.

14. The insulation system according to claim 1, wherein said vapor retarder material is selected from the group consisting of polyester film, polypropylene film, polyethylene nylons, polycarbonate polymer, polyvinylidene chloride, polyvinylidene copolymers, film forming copolymers, co-extruded products, and polyester co-extruded products.

15. The insulation system according to claim 14, wherein the vapor retarder is a polyester film having a thickness between about 3 and 5 mil.

16. An insulation system which comprises:
a tubular layer of insulation including a longitudinal slit therein for allowing a pipe to be received within said tubular layer of insulation;
a polymeric vapor retarder extending from a first side of the slit in said layer of insulation to a second side of the slit to encompass the layer of insulation and having a flap from the first side of the slit to the second side of the slit and attachable to the vapor retarder at the second side of the slit; and
a wick disposed within the inner periphery of the insulation and extending through the slit to the outer periphery of the insulation.

17. The insulation product of claim 16, wherein the wicking material extends from a first side of the slit to the inside of the slit to a second side of the slit.

18. The insulation product of claim 16, wherein the wicking material comprises a nonwoven material including a striated polymer fiber.

19. The insulation product of claim 18, wherein the striated polymer is rayon.
